(19) United States
(12) Patent Application Publication
(10) Pub. No.: US 2008/0095913 A1
(43) Pub. Date: Apr. 24, 2008

(54) Process for Making Tea Extracts

(76) Inventors: Timothy Graham Jones, Bedfordshire (GB); Richard Safford, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/663,947

(22) PCT Filed: Sep. 21, 2005
(86) PCT No.: PCT/EP05/10396

§ 371 Date: Mar. 27, 2007

(30) Foreign Application Priority Data
Oct. 1, 2004 (GB) 0421830.1

(51) Int. Cl. A23F 3/16

(52) U.S. Cl. 426/597; 426/435

(57) ABSTRACT

The invention concerns a process for preferentially extracting theanine from tea plant material which involves a short cold water extraction.

The present invention relates to a process for making theanine-rich tea extract.

### BACKGROUND AND PRIOR ART

Tea is generally prepared as green leaf tea or black leaf tea. The method of preparing such teas is well known to those skilled in the art. Generally, to prepare black leaf tea, fresh green leaves of the plant Camellia sinensis are withered (subjected to mild drying), comminuted, fermented (in which enzymes in the leaf tea oxidise various substrates to produce brown-coloured products) and then fired (to dry the tea leaves). Green leaf tea is not exposed to the fermentation process. Partial fermentation may be used to produce intermediate-type teas known as “oolong” tea.

Today tea based beverages can be prepared by methods other than infusing leaves in hot water and served in ways other than poured from tea pots. For example they can be made with concentrates or powders that are mixed with hot water in vending machines or used to prepare ready to drink teas in cans and bottles. Consumers also demand more from tea such as accelerated infusion, more colour, more aroma.

In particular the modern consumer is particularly interested in naturally healthy beverages which form part of a modern healthy lifestyle. As a beverage, tea fits well with this attitude in view of its natural content of inter alia flavonoids, catechins and amino acids. There is therefore a need in the art to provide a method for the concentration of these naturally occurring healthy ingredients whilst maintaining the healthy nature of tea without adding synthetic compounds.

One such ingredient is theanine. Theanine has been found to have numerous beneficial effects on the human body and mind. However, currently this is only available in high quantities in a synthetic sun-theanine form. This is largely due to the fact that naturally occurring theanine only comprises about 1% of the extractable tea solids in tea plant material.

GB 559,758 discloses a cold water infusion followed by a hot water infusion of black tea leaves. The cold water extract and the hot water extract are separately dried to a powder. The cold water infusion step takes at least 4 hours.

EP 110 391 discloses a cold water infusion followed by a hot water infusion of black leaf tea in order to provide an instant cold water-soluble ice tea powder. The cold water infusion step is shorter than in GB 559,758, and is exemplified by an extraction at room temperature for 10 minutes. The two extracts are mixed together, the mixture is then concentrated and then dried.

EP 267 660 again discloses a cold water infusion followed by a hot water infusion of black leaf tea but in order to provide a hot-water instant tea powder. In this case the two infusions are concentrated by reverse osmosis up to a maximum of 25 wt % solids content prior to recombination.

O. Kuntze, “Effect of extraction temperature on cream and extractability of black tea” Int. Journal of Food Sci and Tech (2003), 38, 37-45 discloses that a water extraction of as high as 50° C. results in the majority of the components responsible for formation of the cream remain unextracted. However, because an extraction at 50° C. gives a low yield, leaving a large amount of tea solids in the leaf, the paper suggests that a second infusion at 90° C. could follow so that the remaining tea solids can be extracted for normal hot drinking instant tea purposes.

WO2005/042470 discloses a process for extracting theanine from tea comprising the steps of extraction, contact with an adsorbent and then filtration. This does not disclose a short cold extraction and the preferred initial extraction involves steeping tea leaves in hot water.

The present inventors have surprisingly discovered that performing a short cold water extraction on fermented tea leaves, provides a very effective way of extracting a high percentage of the amino acids from the tea leaves whilst leaving behind the vast majority of the remaining tea solids. This has the further advantage that further extraction of tea solids with a traditional hot water extraction provides a further extract which is useful on its own as a starting material for ice tea.

Thus, the present invention is a process to provide an amino acid-rich tea extract comprising the steps of:
(i) performing a cold water extraction of tea plant material using water at a temperature of from 1 to 50° C. for a time period of from 1 to 120 minutes to provide a cold-water tea extract;
(ii) drying the cold-water tea extract to provide a concentrated cold-water extract comprising more than 40 wt % tea solids.

In a second aspect, the invention provides a tea extract comprising from 40 to 100 wt % of tea solids, wherein the tea solids comprise from 2 to 8 wt % theanine.

### DETAILED DESCRIPTION OF THE INVENTION

Tea Starting Material

The starting material of the present invention is tea plant material. Material from Camellia sinensis, Camellia assamica, or Aspalathus linearis. Preferably the starting material is black tea, in which the leaves and/or stem are subjected to a so-called “fermentation” step wherein they are oxidised by certain endogenous enzymes that are released during the early stages of “black tea” manufacture. This oxidation may even be supplemented by the action of exogenous enzymes such as oxidases, laccases and peroxidases. The fermentation process is believed to polymerise the polyphenols which reduced their extraction rate in cold water, thus increasing the theanine concentration in the extract.

Cold Water Extraction

The cold water extraction is carried out with water at a temperature of from 1 to 50° C. for a time period of from 1 to 120 minutes. Preferably, the temperature and duration are such that the product of the temperature in degrees Celsius and the duration of the extraction in minutes (Cmins) is from 30 to 1000, preferably from 100 to 500.

The cold water extraction step may be carried out in a batchwise or continuous manner. When run continuously, the extraction time refers to the mean residence time of the tea leaf.

Preferably the water is at a temperature of from 3 to 30° C., preferably from 5 to 20° C.

Preferably the extraction is for a time period of from 5 to 60 minutes, or even from 10 to 45 minutes.

The extraction may be carried out in any suitable contacting equipment, for example a stirred tank.

Preferably the water-to-leaf weight ratio is from 5:1 to 50:1, more preferably from 10:1 to 30:1.

Following extraction the extract is preferably filtered to remove the leaves. The liquor is then preferably centrifuged to remove any coarse material which manages to pass through the filter. Another preferential step is demineralisation of the liquor.

Preferably, the cold-water extract is also demineralised by any suitable process known in the art.

Concentration Step

The enriched extract will need to be concentrated because it normally comprises over 99 wt % water. This may be achieved by passing the enriched extract through a nanofilter with a theanine rejection of greater than 80%. In this way, a retentate is provided with most of the theanine but with an order of magnitude less water.

Another way of concentrating is to use reverse osmosis. Such a process will act as a purely concentration step as only water is permitted to pass the filter in such a process.

Because of the thermal instability of theanine, it is preferred that the concentration step does not involve the temperature of the extract exceeding 80° C. for more than 20 minutes and does not exceed 60° C. for more than 40 minutes.

The cold water is then further concentrated to form a liquid concentrate or a powdered cold water extract. This may be achieved by freeze drying for example. The final concentrate comprises at least 40 wt %, preferably at least 60 wt %, more preferably at least 80 wt % tea solids.

Preferably the cold-water extract is also treated with polyvinyl pyrolidone to precipitate polyphenolics.

Optional Hot Water Extraction

When the cold water extraction of the present invention is carried out, the tea leaves are such that they can still be used for the purposes of providing tea extract in a conventional ice tea production process. Therefore there is no waste of tea leaves whilst also obtaining good extraction of the amino acids.

### EXAMPLES

### Example 1

Black tea leaves were infused in water at a temperature of 5° C. for a duration of 10 minutes (Cmins=50). The tea leaves were separated from the liquor which was then centrifuged to remove coarse material, leaving an aqueous tea extract having 0.58 wt % dry solids comprising 5.9 wt % theanine upon analysis.

The liquor was passed through a reverse osmosis step to remove water, yielding a liquor having approximately 10 wt % dry solids, comprising 5.9 wt % theanine. Such a liquor could be further freeze dried to provide a 5.9 wt % theanine powder.

### Example 2

Black tea leaves were infused in water at a temperature of 15° C. for a duration of 10 minutes (Cmins=150). The tea leaves were separated from the liquor which was then centrifuged to remove coarse material, leaving an aqueous tea extract having 0.80 wt % dry solids comprising 4.3 wt % theanine upon analysis.

The liquor was passed through rotary evaporation under 72 mbar vacuum to remove water, yielding a liquor having 10.6 wt % dry solids. Polyvinyl polypyrrolidone (PVPP) was added to the liquor at a quantity of 0.5 g PVPP per 1 g dry solids in the liquor. This was stirred for 30 minutes, then the PVPP was removed from the liquor by filtration. This left an aqueous tea concentrate having 9.3 wt % dry solids comprising 5.0 wt % theanine upon analysis. Such a liquor could be further freeze dried to provide a 5.0 wt % theanine powder.

1. A process to provide an amino acid-rich tea extract comprising the steps of:
(i) performing a cold water extraction of tea plant material using water at a temperature of from 1 to 30° C. for a time period of from 1 to 120 minutes to provide a cold-water tea extract;
(ii) concentrating the cold-water tea extract to provide a concentrated cold-water extract comprising more than 40 wt % tea solids.

2. A process according to claim 1, wherein the starting material is fermented tea plant material.

3. A process according to claim 1, wherein the starting material comprises tea stem.

4. A process according to claim 1, wherein the water is at a temperature of from 3 to 30° C., preferably from 5 to 20° C.

5. A process according to claim 1, wherein the cold-water extract is also demineralised.

6. A process according to claim 1, wherein the cold water extraction is for a time period of from 5 to 60 minutes.

7. A process according to claim 1, wherein a hot water extraction is performed on the tea leaves which have been cold-water extracted using water at a temperature of from 50 to 10° C. to provide a hot-water tea extract.

8. A process according to claim 1, wherein the cold-water extract is also treated with polyvinyl pyrolidone to precipitate polyphenolics.

9. A process according to claim 1, wherein the concentration step does not involve the temperature of the extract exceeding 80° C. for more than 20 minutes and does not exceed 60° C. for more than 40 minutes.

10. A tea extract comprising from 40 to 100 wt % of tea solids, wherein the tea solids comprise from 2 to 8 wt % theanine.
